(19) United States
(12) Patent Application Publication
(10) Pub. No.: US 2013/0109830 A1
(43) Pub. Date: May 2, 2013

(54) POLYURETHANE ELASTOMERS, A METHOD FOR PRODUCING SAME, AND USE THEREOF

(71) Applicants: Jens Krause, Leverkusen (DE); Manfred Schmidt, Dormagen (DE)

(72) Inventors: Jens Krause, Leverkusen (DE); Manfred Schmidt, Dormagen (DE)

(73) Assignee: Bayer Intellectual Property GmbH, Monheim (DE)

(21) Appl. No.: 13/696,448

(22) PCT Filed: May 2, 2011
(86) PCT No.: PCT/EP2011/056955

§ 371 Date: Jan. 15, 2013

(30) Foreign Application Priority Data
May 7, 2010 (DE) 10 2010 019 701.7

(51) Int. Cl. C08G 18/76

(52) U.S. Cl. CPC C08G 18/7692
USPC 528/65; 560/336; 560/330

(57) ABSTRACT

The invention relates to cellular and non-cellular polyurethane (PUR) elastomers made of NCO functional prepolymers based on polyisocyanates having portions of non-monomers, to a method for producing same, and to the use thereof.

The present invention relates to cellular and noncellular polyurethane (PUR) elastomers derived from NCO-functional prepolymers based on polyisocyanates with proportions of trimers, a process for preparing them and their use.

Polyurethane elastomers are used in numerous wear-susceptible applications. Apart from wear by, for example, abrasion and/or lack of tear propagation resistance, there is wear due to deformation and/or heat buildup after a particular number of repeated subjections to stress in dynamic applications such as rollers, wheels, seals, cellular buffer elements and cellular shoe soles. These stresses are usually periodic. Here, high permanent deformations occur and make further use impossible. In addition, the internal heat buildup (due to nonelastic interactions) can be so high that the polyurethane heats up to such an extent that it disintegrates under the stress. Furthermore, it is known that the dynamic stability increases when the functionally of the polyol is increased to above 2, but the tear propagation values at the same time decrease so much that the elastomer is destroyed by nondynamic wear phenomena.

It was therefore an object of the invention to provide an elastomer which has a low functionality and at the same time displays very good tear propagation resistance and very good dynamic behaviour.

It has now surprisingly been found that the mechanical properties (e.g. abrasion, yield stress, tear propagation resistance, elongation at break) of polyurethanes can be produced with simultaneously improved dynamic properties by use of specific NCO prepolymers based on polyisocyanates as specified in more detail below without changing the mechanophysical properties.

The invention provides a process for preparing polyurethane elastomers, which is characterized in that
a) monomeric polyisocyanate is reacted by means of a trimerization catalyst in an amount of from 0.1 to 2000 ppm, based on monomeric polyisocyanate, where the reaction with the trimerization catalyst is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,
b) the mixture of monomeric and reacted polyisocyanate from a) is reacted with polyols having OH numbers of from 20 to 200 mg KOH/g and functionalities of from 1.95 to 2.40 to give an NCO-terminated prepolymer,
c) the NCO-terminated prepolymer is reacted with chain extenders and/or crosslinkers to give the polyurethane elastomer,
where the monomeric polyisocyanate and/or the polyols can optionally contain auxiliaries and/or additives.

The invention further provides a process for preparing NCO-terminated prepolymers, which is characterized in that
a) monomeric polyisocyanate is reacted by means of a trimerization catalyst in an amount of from 0.1 to 2000 ppm, based on monomeric polyisocyanate, where the reaction with the trimerization catalyst is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,
b) the mixture of monomeric and reacted polyisocyanate from a) is reacted with polyols having OH numbers of from 20 to 200 mg KOH/g and functionalities of from 1.95 to 2.40 to give an NCO-terminated prepolymer,
where the monomeric polyisocyanate and/or the polyols can optionally contain auxiliaries and/or additives.

The invention further provides a process for preparing mixtures of monomeric and nonmonomeric polyisocyanates, which is characterized in that
a) monomeric polyisocyanate is reacted by means of a trimerization catalyst in an amount of from 0.1 to 2000 ppm, based on monomeric polyisocyanate, where the reaction with the trimerization catalyst is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,

where the monomeric polyisocyanate can optionally contain auxiliaries and/or additives.

The invention also provides polyurethane elastomers which can be obtained from
a) a mixture of monomeric and nonmonomeric polyisocyanate having a proportion of from 0.01 to 5.0% by weight of nonmonomeric polyisocyanate, based on the total polyisocyanate, where the mixture can be obtained from monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1,
b) polyols having OH numbers of from 20 to 200 mg KOH/g and functionalities of from 1.95 to 2.40 and
c) chain extenders and/or crosslinkers,
d) optionally in the presence of auxiliaries and/or additives.

The invention further provides NCO-terminated prepolymers which can be obtained from
a) a mixture of monomeric and nonmonomeric polyisocyanate having a proportion of from 0.01 to 5.0% by weight of nonmonomeric polyisocyanate, based on the total polyisocyanate, where the mixture can be obtained from monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1, and
b) polyols having OH numbers of from 20 to 200 mg KOH/g and functionalities of from 1.95 to 2.40,
d) optionally in the presence of auxiliaries and/or additives.

The invention further provides mixtures of monomeric and nonmonomeric polyisocyanate having a proportion of from 0.01 to 5.0% by weight of nonmonomeric polyisocyanate, based on the total polyisocyanate, which can be obtained from
a) monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1.

The reaction is carried out by means of conventional trimerization catalysts as are described in Houben-Weyl, Methoden der Organischen Chemie, volume E20, part 2, Georg Thieme Verlag, Stuttgart, 1987, pp. 1739-1751, e.g. quaternary ammonium hydroxides, benzyldimethylamine, triethylamine, Mannich bases of phenols or mixtures of these catalysts. Preference is given to employing phenol Mannich bases which can be obtained by reaction of phenol or bisphenol A with dimethylamine and formaldehyde. The trimerization catalyst can be present in a solvent, e.g. toluene, ethyl acetate, alcohol (e.g. methanol, ethanol and 2-ethyl-1 -hexanol), ethers or polyethers, phosphoric esters such as tris(2-chloroisopropyl) phosphate (TCPP) or triethyl phosphate (TEP).

After the desired conversion, the reaction is stopped, preferably by means of Brønsted or Lewis acids such as hydrochloric acid, benzoyl chloride or organic mineral acids such as dibutyl phosphate.

The polyurethane elastomers according to the invention have very good dynamic properties combined with good mechanophysical properties.

The polyurethane elastomers of the invention are preferably used as pourable elastomers for the production of, for example, rollers, wheels and conveyor belts.

The polyurethane elastomer parts are preferably produced by the casting process. Here, the NCO-terminated prepolymers are prepared first. The NCO-terminated prepolymers are reacted either immediately after they have been produced with a chain extender/crosslinker, or they are cooled to low temperatures (storage temperature) and stored for the purpose of later chain extension/crosslinking.

A particular advantage in the synthesis via NCO-terminated prepolymers is that part of the heat of reaction is evolved during the synthesis of the NCO-terminated prepolymer and as a result the heat evolved in the actual polymer buildup to give the elastomer is lower. This has a favourable effect on the rate of molecular weight buildup and makes longer casting times possible, i.e. represents a processing advantage.

In a particularly preferred embodiment, the NCO-terminated prepolymers are firstly degassed by application of a reduced pressure at room temperature or at elevated temperature and then reacted, usually at elevated temperature, with the chain extender/crosslinker.

In the process of the invention, the NCO-terminated prepolymer is preferably heated to a temperature of from 60° C. to 110° C. and degassed under reduced pressure while stirring. The chain extender and/or crosslinker is then added in liquid form, with this optionally being heated to temperatures of typically at least 5° C. above its melting point. This reaction mixture is preferably poured into preheated moulds (preferably from 90° C. to 120° C.) and maintained at from 90° C. to 140° C. for about 24 hours.

The NCO-functional prepolymers are preferably prepared from the following polyisocyanates: NDI (naphthalene 1,5-diisocyanate), TDI (tolylene 2,4- and 2,6-diisocyanate or mixtures thereof), MDI (2,2′-, 2,4′- and 4,4′-MDI or mixtures thereof), TODI (3,3′-dimethylbiphenyl 4,4′-diisocyanate), PPDI (paraphenylene 1,4-diisocyanate) and CHDI (cyclohexyl diisocyanate) and also mixtures of the polyisocyanates and/or modified compounds of the polyisocyanates, e.g. uretonimines, polymers of the isocyanates (polymeric MDI, for example Desmodur® 44V20L from Bayer MaterialScience AG) or other modified isocyanates. As an alternative, but less preferred, it is possible to use or mix in aliphatic isocyanates such as isophorone diisocyanate, ring-hydrogenated MDI (e.g. Desmodur® W) and hexamethylene diisocyanate and also derivatives of these isocyanates.

In a specific embodiment, the NCO-functional prepolymers are prepared using an excess of isocyanate. In a further step, the free isocyanate is removed so as to reduce the content of free isocyanate to <1% by weight, preferably to <0.1% by weight. The removal is usually carried out under reduced pressure (for example by means of thin film or short path and/or falling film evaporators). Entrainers can optionally be used for this purpose. The entrainer can be, for example, a solvent or a gas, e.g. nitrogen.

These NCO-prepolymers obtained in this way can, for example, be mixed with blocked amines such as blocked diaminodiphenylmethane (e.g. Caytur® 31) and be used as two-component system (sometimes also referred to as one-component system in the literature).

As polyols, it is possible to use, for example, polyether polyols, polyester polyols, polycarbonate polyols and polyether ester polyols having hydroxyl numbers (OH numbers) of from 20 to 200 mg KOH/g, preferably from 27 to 150, particularly preferably from 27 to 120.

Polyether polyols are prepared from a starter molecule and epoxides, preferably ethylene oxide or propylene oxide, either by means of alkaline catalysis or by means of double metal cyanide catalysis or optionally, in the case of stepwise reaction, by means of alkaline catalysis and double metal cyanide catalysis and have terminal hydroxyl groups. Possible starters are the compounds which are known to those skilled in the art and have hydroxyl and/or amino groups, and also water. The functionality of the starters here is at least 2 and not more than 4. Of course, it is also possible to use mixtures of a plurality of starters. Furthermore, mixtures of a plurality of polyether polyols can also be used as polyether polyols. As an alternative, polyether polyols on a C₄ basis, e.g. polytetrahydrofuran, can also be preferably used. Furthermore, C₃-polyols based on 1,3-propylene glycol can also be used.

Polyester polyols are prepared in a manner known per se from aliphatic and/or aromatic polycarboxylic acids having from 4 to 16 carbon atoms, optionally from their anhydrides or optionally from their low molecular weight esters, including cyclic esters, by polycondensation, predominantly using low molecular weight polyols having from 2 to 12 carbon atoms as reaction component. The functionality of the formative components for polyester polyols is preferably 2, but can in an individual case also be greater than 2, with the components having functionalities of greater than 2 being used only in minor amounts so that the arithmetic number average functionality of the polyester polyols is in the range from 2 to 2.5, preferably from 2 to 2.1.

Polyether ester polyols are prepared, for example, by concomitant use of polyether polyols in the polyester polyol synthesis.

Polycarbonate polyols are obtained according to the prior art, e.g. from carbonic acid derivatives, e.g. dimethyl carbonate or diphenyl carbonate or phosgene, and polyols by means of polycondensation.

As chain extenders and/or crosslinkers, it is possible to use, for example, aromatic amine-type substances such as diethyltoluenediamine (DETDA), 3,3′-dichloro-4,4′-diaminodiphenylmethane (MBOCA), 3,5-diamino-4-chloroisobutyl benzoate, 4-methyl-2,6-bis(methylthio)-1,3-diaminobenzene (Ethacure 300), trimethylene glycol di-p-aminobenzoate (Polacure 740M) and 4,4′-diamino-2,2′-dichloro-5,5′-diethyldiphenylmethane (MCDEA) and 4,4′-diamino-diphenylmethane (MDA) or MDA blocked by means of salts (Caytur 21, 31 etc. from Chemtura). Aliphatic amine-type chain extenders or crosslinkers can likewise be used or concomitantly used. It is likewise possible to use chain extenders or crosslinkers from the group of polyols, for example 1,2-ethanediol, 1,2-propanediol, 1,3-propanediol, 1,4-butanediol, glycerol, trimethylolpropane and mixtures of these. Particular preference is given to using 1,4-butanediol as chain extender.

Furthermore, auxiliaries and additives such as catalysts, stabilizers, UV stabilizers, hydrolysis inhibitors, emulsifiers, preferably incorporatable dyes, and colour pigments, cell regulators and fillers can be used.

Examples of catalysts are trialkylamines, diazabicyclooctane, tin dioctoate, dibutyltin dilaurate, N-alkylmorpholine, lead octoate, zinc octoate, calcium octoate, magnesium octoate, the corresponding naphthenates and p-nitrophenoxide.

Examples of stabilizers are Brønsted and Lewis acids such as hydrochloric acid, benzoyl chloride, organic mineral acids, e.g. dibutyl phosphate, and also adipic acid, malic acid, succinic acid, tartaric acid or citric acid.

Examples of UV stabilizers and hydrolysis inhibitors are 2,6-dibutyl-4-methylphenol and sterically hindered carbodiimides.

Incorporatable dyes are those which have Zerevitinov-active hydrogen atoms, i.e. can react with NCO groups.

An overview is given in G. Oertel, Polyurethane Handbook, 2^{nd} edition, Carl Hanser Verlag, Munich, 1994, chapter 3.4.

The polyurethane elastomers prepared according to the invention are preferably used for producing pourable elastomers for, for example, rolls, wheels, rollers, hydrocyclones, sieves, pipeline pigs and also cellular and noncellular elastomers for buffer elements.

The invention is illustrated by the following examples.

### EXAMPLES

Compounds used:

Catalyst: Accelerator 960-1 from Huntsman (2,4,6-tris(dimethylaminomethyl)phenol)

MDI: Desmodur® 44M from Bayer MaterialScience AG (monomeric diphenylmethane 4,4′-di-isocyanate); NCO content: 33.6% by weight

Polyester polyol: molecular weight 2000 g/mol based on monoethylene-butylene glycol adipates, Desmophen® 2001KS from Bayer MaterialScience AG

Stopper: benzoyl chloride

BDO: 1,4-butanediol

Prepolymer 1 (according to the invention):

The MDI was placed in a reaction vessel at 60° C., admixed with 200 ppm, based on MDI, of catalyst and stirred for 1 hour 30 minutes. The reaction mixture was then admixed with a 1.5 molar excess of stopper. The NCO content was found to be 32.9% by weight. 34.218 parts by weight of this mixture were admixed at 60° C. with 65.682 parts by weight of polyester polyol at 60° C. and the two were reacted with one another for 3 hours at 80° C. while stirring. The NCO content of the prepolymer was found to be 8.42% by weight. The prepolymer contained undissolved particles and could be processed manually to give an elastomer.

Prepolymer 2 (according to the invention):

Part of prepolymer 1 was taken off and filtered so that no undissolved particles are present. Particles can interfere in machine processing under some circumstances. The NCO content was found to be 8.40% by weight.

Prepolymer 3 (according to the invention):

The MDI was placed in a reaction vessel at 60° C., admixed with 50 ppm, based on MDI, of catalyst and stirred for 1 hour 30 minutes. The reaction mixture was then admixed with a 1.5 molar excess of stopper. The NCO content was found to be 33.5% by weight. 33.72 parts by weight of MDI were admixed at 60° C. with 66.28 parts by weight of polyester polyol at 60° C. and the two were reacted with one another for 3 hours at 80° C. while stirring. The NCO content of the prepolymer was found to be 8.50% by weight. The prepolymer did not contain any undissolved particles.

Prepolymer 4 (not according to the invention):

33.61 parts by weight of MDI were admixed at 60° C. with 66.39 parts by weight of polyester polyol at 60° C. and the two were reacted with one another for 3 hours at 80° C. while stirring. The NCO content of the prepolymer was found to be 8.37% by weight. The prepolymer did not contain any undissolved particles.

Polyurethane elastomer:

100 parts by weight of prepolymer were in each case reacted at 80° C. with 1,4-butanediol (amounts are indicated in Table 1) and poured into a hot mould at 120° C. The mechanical properties were measured after 7 days.

TABLE 1
Processing details and mechanical results for the respective polyurethane elastomers

| | | | Polyurethane elastomer from: | | | |
|---|---|---|---|---|---|---|
| | | | Prepolymer 4 | | | |
| | | | comparison | Prepolymer 1 | Prepolymer 2 | Prepolymer 3 |
| NCO content | | [% by | 8.37 | 8.42 | 8.4 | 8.5 |
| | | weight] | | | | |
| 1,4-Butanediol | | [parts by | 8.55 | 8.60 | 8.60 | 8.69 |
| | | weight] | | | | |
| Pot life | | [sec.] | 225 | 300 | 300 | 240 |
| Demoulding time | | [min.] | 45 | 70 | 70 | 45 |
| Mechanical | | | | | | |
| properties: | | | | | | |
| Hardness at 20° C. | DIN 53505 | Shore A | 92 | 91 | 91 | 92 |
| Hardness at −5° C. | DIN 53505 | Shore A | 95 | 95 | 95 | 95 |
| Hardness at 80° C. | DIN 53505 | Shore A | 89 | 88 | 88 | 89 |
| 10% modulus | DIN 53504 | [MPa] | 3.3 | 3.2 | 3.4 | 3.4 |
| 100% modulus | DIN 53504 | [MPa] | 7.5 | 7.6 | 7.8 | 7.8 |
| 200% modulus | DIN 53504 | [MPa] | 10.5 | 11 | 10.8 | 11.1 |
| 300% modulus | DIN 53504 | [MPa] | 14.7 | 15.7 | 14.8 | 15.4 |
| Yield stress | DIN 53504 | [MPa] | 54 | 49 | 57 | 55 |
| Elongation at break | DIN 53504 | [%] | 557 | 515 | 570 | 562 |
| Tear propagation | DIN 53515 | [kN/m] | 119 | 116 | 117 | 120 |
| resistance | | | | | | |
| Tear propagation | DIN 53515 | [kN/m] | 65 | 63 | 72 | 66 |
| resistance (scored) | | | | | | |
| Rebound resilience | DIN 53512 | [%] | 47 | 42 | 45 | 45 |
| Abrasion | DIN 53516 | [mm³] | 30 | 30 | 30 | 30 |
| Compression set | DIN 53517 | [%] | 18 | 17 | 17 | 18 |
| 24 h/70° C. | | | | | | |

It can be seen from Table 1 that the mechanical properties are not changed within measurement accuracy by the partial reaction.

TABLE 2
Dynamic results for the polyurethane elastomers
Cylinders made of polyurethane elastomer and having a diameter of 18 mm and a height of 25 mm
were tested in each case. The cylinder was compressed in pulses with a force of 1.2 kN and a
fixed frequency at an amplitude of 0.8 kN. The test was stopped at a deformation of 60%.

| | | Elastomer from: | | | |
|---|---|---|---|---|---|
| | | Prepolymer 4 | | | |
| | | comparison | Prepolymer 1 | Prepolymer 2 | Prepolymer 3 |
| NCO content | [% by weight] | 8.37 | 8.42 | 8.4 | 8.5 |
| 1,4-Butanediol | [parts by weight] | 8.55 | 8.60 | 8.60 | 8.69 |
| Cycles at 10 Hz | number | 1733 | 2592 | 3351 | 3418 |
| Cycles at 2.5 Hz | number | 5176 | not determined | 16000⁺⁾ | 16000⁺⁾ |

⁺⁾Test was stopped after 16 000 cycles. 60% deformation had not yet been reached.

It is clear from the test results that a partial reaction increases the dynamic performance by a factor of 2-3 without the mechanophysical properties or the processing being adversely affected. Even at a low conversion, elastomers having good mechanophysical properties and very good dynamic properties are obtained without particles being formed and possibly having to be filtered off before machine processing.

The systems according to the invention display a unique combination of advantageous properties in respect of prepolymer viscosity, casting time, mechanical and dynamic mechanical properties.

1. Process for preparing polyurethane elastomers, characterized in that
a) monomeric polyisocyanate is reacted by means of a trimerization catalyst in an amount of from 0.1 to 2000 ppm, based on monomeric polyisocyanate, where the reaction is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,
b) the mixture of monomeric and reacted polyisocyanate from a) is reacted with polyols having OH numbers of from 20 to 200 mg KOH/g and functionalities of from 1.95 to 2.40 to give an NCO-terminated prepolymer,
c) the NCO-terminated prepolymer is reacted with chain extenders and/or crosslinkers to give the polyurethane elastomer,
where the monomeric polyisocyanate and/or the polyols can optionally contain auxiliaries and/or additives.

2. Process for preparing NCO-terminated prepolymers, characterized in that
a) monomeric polyisocyanate is reacted by means of a trimerization catalyst in an amount of from 0.1 to 2000 ppm, based on monomeric polyisocyanate, where the reaction is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,
b) the mixture of monomeric and reacted polyisocyanate from a) is reacted with polyols having OH numbers of from 20 to 200 mg KOH/g and functionalities of from 1.95 to 2.40 to give an NCO-terminated prepolymer,
where the monomeric polyisocyanate and/or the polyols can optionally contain auxiliaries and/or additives.

3. Process for preparing mixtures of monomeric and nonmonomeric polyisocyanates, characterized in that
a) monomeric polyisocyanate is reacted by means of a trimerization catalyst in an amount of from 0.1 to 2000 ppm, based on monomeric polyisocyanate, where the reaction is stopped at a proportion of from 0.01 to 5.0% by weight of reacted polyisocyanate, based on the total polyisocyanate, by means of a stopper which is used in a molar ratio of stopper to trimerization catalyst from 1:2 to 20:1,
where the monomeric polyisocyanate can optionally contain auxiliaries and/or additives.

4. Polyurethane elastomers which can be obtained from
a) a mixture of monomeric and nonmonomeric polyisocyanate having a proportion of from 0.01 to 5.0% by weight of nonmonomeric polyisocyanate, based on the total polyisocyanate, where the mixture can be obtained from monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1,
b) polyols having OH numbers of from 20 to 200 mg KOH/g and functionalities of from 1.95 to 2.40 and
c) chain extenders and/or crosslinkers,
d) optionally in the presence of auxiliaries and/or additives.

5. NCO-terminated prepolymers which can be obtained from
a) a mixture of monomeric and nonmonomeric polyisocyanate having a proportion of from 0.01 to 5.0% by weight of nonmonomeric polyisocyanate, based on the total polyisocyanate, where the mixture can be obtained from monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1, and
b) polyols having OH numbers of from 20 to 200 mg KOH/g and functionalities of from 1.95 to 2.40,
d) optionally in the presence of auxiliaries and/or additives.

6. Mixtures of monomeric and nonmonomeric polyisocyanate having a proportion of from 0.01 to 5.0% by weight of nonmonomeric polyisocyanate, based on the total polyisocyanate, which can be obtained from
a) monomeric polyisocyanate by means of a trimerization catalyst in an amount of from 0.1 to 2000 ppm, based on monomeric polyisocyanate, and by means of a stopper in a molar ratio of stopper to trimerization catalyst of from 1:2 to 20:1.

7. Use of the polyurethane elastomers for producing pourable elastomers for, for example, rolls, wheels, rollers, hydrocyclones, sieves, pipeline pigs and also cellular and noncellular elastomers for buffer elements.
